(19) United States
(12) Patent Application Publication
(10) Pub. No.: US 2009/0157825 A1
(43) Pub. Date: Jun. 18, 2009

(54) TECHNIQUE FOR PROVIDING A COLLAPSIBLE SECTION IN AN INSTANT MESSAGE DIALOGUE

(76) Inventors: LAQUICIA S. BARBEE, Durham, NC (US); RYAN A. BOYLES, Wake Forest, NC (US); JOSEPH E. FIREBAUGH, Corinth, TX (US); JASON C. PLURAD, Raleigh, NC (US)

Correspondence Address: DILLON & YUDELL LLP, 8911 N. CAPITAL OF TEXAS HWY., SUITE 2110, AUSTIN, TX, 78759, US

(21) Appl. No.: 11/958,480

(22) Filed: Dec. 18, 2007

(51) Int. Cl. G06F 15/16

(52) U.S. Cl. 709/206

(57) ABSTRACT

A technique for displaying instant messages includes creating a collapsible section in an instant message dialogue. Information is incorporated into the collapsible section of the instant message dialogue. The information is then selectably displayed in the instant message dialogue.

### BACKGROUND

1. Field

This disclosure relates generally to instant messaging and, more specifically, to a technique for providing a collapsible section in an instant message dialogue.

2. Related Art

Instant messaging (IM) is a form of real-time communication between two or more individuals that has traditionally been based on typed text, which is conveyed via devices (e.g., desktop computer systems) connected over a network (e.g., the Internet). IM generally facilitates near instantaneous communication between a number of individuals by transmitting information quickly and efficiently. IM facilitates collaboration, which might be considered more akin to genuine dialogue, as contrasted with the letter format of email. In contrast to email, IM parties generally know whether a peer is available, as most instant message applications allow a user to set an online status or away message such that peers are notified when a user is available, busy, or away from an associated device that is running the instant message application. Some instant message applications allow the sending of messages (i.e., offline messages) to people not currently logged on, which removes much of the difference between IM and email. At least some instant message applications offer video conferencing features, voice over Internet protocol (VoIP), and web conferencing services, which essentially integrate both video conferencing and IM capabilities. Instant message dialogues may be saved for later reference and are typically logged in a local message history which mimics the persistent nature of emails. In general, IM facilitates quick exchange of information, such as uniform resource locators (URLs) or document snippets.

Mobile Instant Messaging (MIM) is a presence enabled messaging service that aims to transpose the desktop messaging experience to the mobile environment. In general, information may be exchanged faster in a mobile environment using an instant message application than using short message service (SMS) text. IM may be employed in a friend-to-friend network, in which each node connects to friends in a so-called ‘friendslist’. This allows for communication with friends of friends and for the building of chat rooms for instant message dialogues with friends on a network. IM has proven to be similar to personal computers, email, and the world-wide web (WWW), in that the adoption of IM for use as a business communications medium has been primarily driven by individual employees using consumer software at work, rather than by formal mandate or provisioning by corporate information technology (IT) departments. Tens of millions of consumer IM accounts are currently used for business purposes by employees of companies and other organizations. In response to the demand for business-grade IM and the need to ensure security and legal compliance, a new type of IM, referred to as enterprise IM (EIM) (e.g., Lotus Sametime™, Microsoft Office Live Communications Server™, and Jabber XCP™), has been introduced.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is an example screen shot associated with an instant message application that is configured to collapse a collapsible section in an instant message dialogue, according to an embodiment of the present disclosure.

FIG. 2 is an example screen shot associated with an instant message application that is configured to expand a collapsible section in an instant message dialogue, according to another embodiment of the present disclosure.

FIG. 3 is a flowchart of a process for providing information in a collapsible section of an instant message dialogue, according to one embodiment of the present disclosure.

FIG. 4 is a block diagram of a computer network whose computer systems may employ instant message applications configured according to the present disclosure.

### DETAILED DESCRIPTION

As will be appreciated by one of ordinary skill in the art, the present invention may be embodied as a method, system, or computer program product. The computer program product may be provided on a computer-usable storage medium (media) having computer-usable program code embodied in the medium (media).

Any suitable computer-usable or computer-readable medium may be utilized. The computer-usable or computer-readable medium may be, for example, but is not limited to, an electronic, magnetic, optical, electromagnetic, infrared, or semiconductor system, apparatus, device, or propagation medium. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device. It should be noted that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store, the program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages. The program code may simultaneously execute on multiple computers that may be remote from each other. The multiple computers may be connected to one another through a local area network (LAN) or a wide area network (WAN), or the connection may be, for example, through the Internet using an Internet service provider (ISP).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

According to various aspects of the present disclosure, techniques are disclosed herein that facilitate improved readability of instant message dialogues (conversations). As IM has become more pervasive, many IM users have migrated from email to IM for everyday communications. While emails were once almost exclusively utilized for longer messages with large amounts of information (including both text and graphics), computer systems users are more frequently cutting and pasting large amounts of information into IM sessions. As a result, a window (viewport) of an instant message dialogue (chat session) may become cluttered and unreadable. According to the present disclosure, a collapsible section (area) button is added to an editor of an instant message application to facilitate the implementation of collapsible sections in an instant message dialogue.

Implementation of collapsible sections in an instant message dialogue allows an IM user to selectably display information in the instant message dialogue and, in this manner, increase the readability of the instant message dialogue, as desired. Information incorporated in a collapsible section of the instant message dialogue may correspond to, for example, text, graphics (e.g., images), or both text and graphics. As used herein, the term “coupled” includes both a direct electrical connection between blocks or components and an indirect electrical connection between blocks or components achieved using intervening blocks or components.

According to one aspect of the present disclosure, a technique for displaying instant messages includes creating a collapsible section in an instant message dialogue. Information (text, graphics, or text and graphics) is incorporated into the collapsible section of the instant message dialogue. The information (that is incorporated into the collapsible section of the instant message dialogue) is then selectably displayed in the instant message dialogue.

According to another aspect of the present disclosure, an instant messaging application stored on a computer-readable storage medium includes first, second, and third code. The first code is configured to create a collapsible section in an instant message dialogue. The second code is configured to incorporate information into the collapsible section of the instant message dialogue. Finally, the third code is configured to selectably display the information (in the collapsible section of the instant message dialogue) in the instant message dialogue.

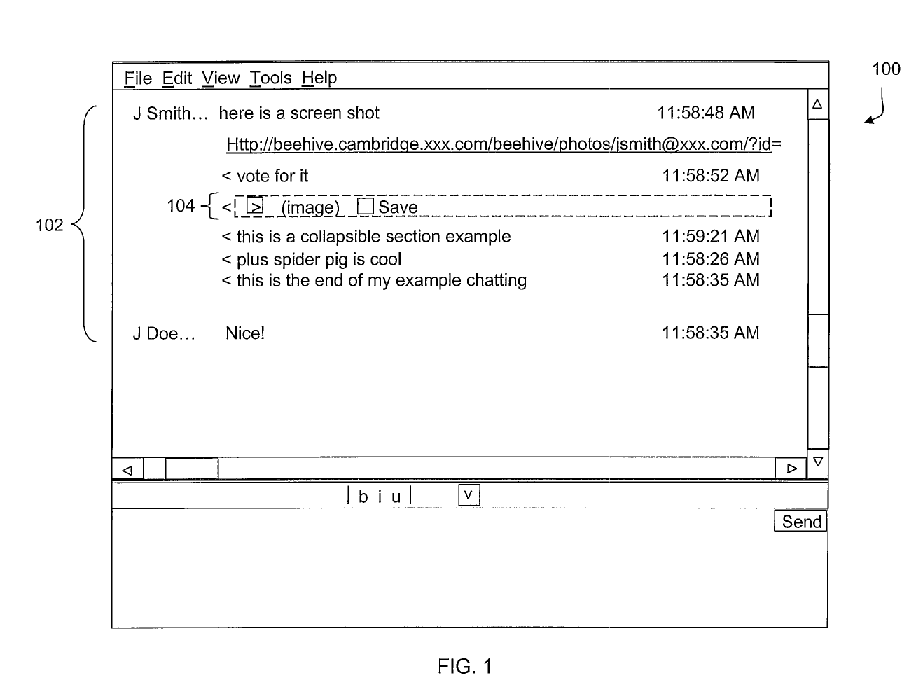

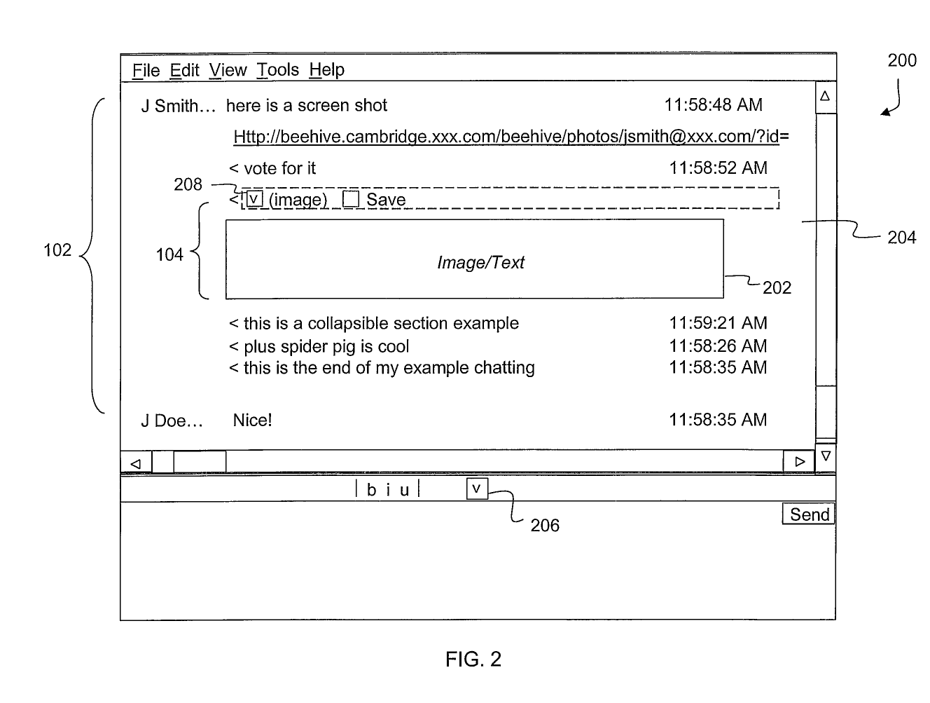

With reference to FIG. 1, a screen shot 100 illustrates an example instant message dialogue 102 that includes a collapsible section 104. As is illustrated, the collapsible section 104 is in a collapsed state to increase readability of the dialogue 102. With reference to FIG. 2, a screen shot 100 illustrates the dialogue 102 with the collapsible section 104 in an expanded state. While the collapsible section 104 is shown as including image/text 202 that does not expand the dialogue 102 outside of window (viewport) 204, it should be appreciated that the image/text 202 may, in some cases, be rather large and expand the dialogue 102 outside the window 204. As is illustrated, a button 206 is provided to allow a user to add an appropriate title (e.g., “image”) to denote content of the collapsible section 104. As is also illustrated, a button 208 allows a user to switch the collapsible section 104 between expanded and collapsed states.

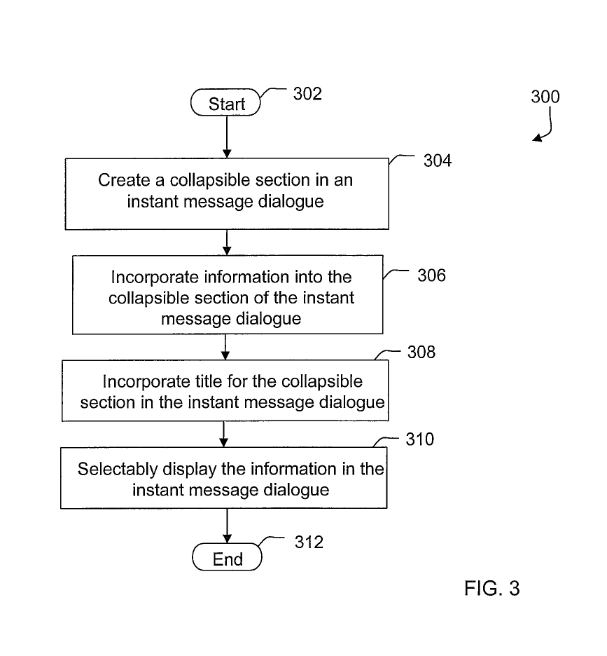

Moving to FIG. 3, a process 300 for implementing and using collapsible sections in instant message dialogues is illustrated. In block 302, the process 300 is initiated at which point control transfers to block 304. In block 304, a collapsible section is created in an instant message. The creation of collapsible sections in applications (such as Lotus Note™) is well known and, as such, is not further addressed herein. Next, in block 306, information (e.g., text, images, or both text and images) is incorporated into the collapsible section of the instant message dialogue. Then, in block 308, a title for the collapsible section may be incorporated into the instant message dialogue by, for example, selecting the button 206 and entering an appropriate title in a pop-up text box. It should be appreciated that incorporating a title (for the collapsible section) in the instant message dialogue is not necessary. However, incorporating a title for the collapsible section allows a user to more readily ascertain whether the information in the collapsible section is germane at a particular point in time. Next, in block 310, the information (in the collapsible section) is selectably displayed (e.g., by selection of the button 208) in the instant message dialogue. Following block 310, control transfers to block 312, where the process 300 returns to a calling process. Accordingly, techniques have been disclosed herein that selectively improve readability of an instant message dialogue.

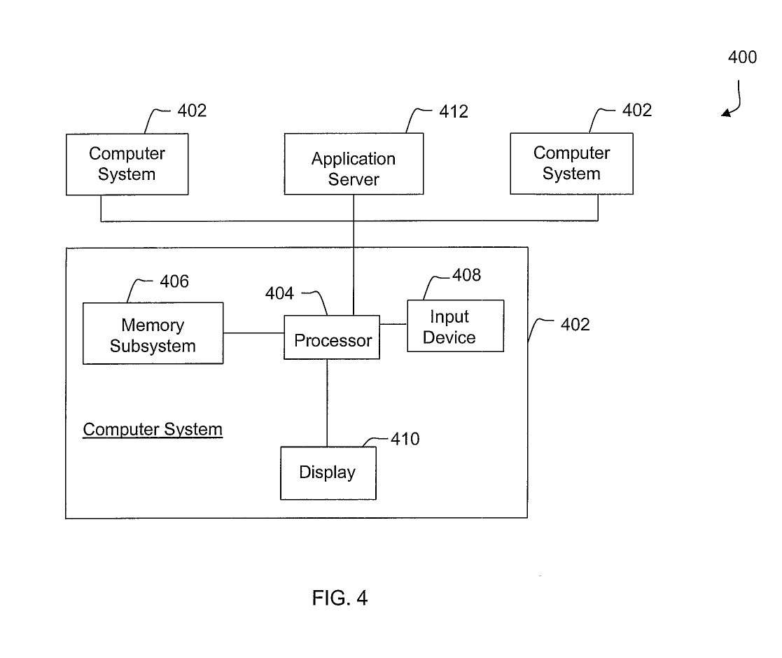

With reference to FIG. 4, an example computer network 400 is illustrated that includes a number of computer systems 402 that are coupled to an application server 412, which may be configured to provide one or more applications (e.g., an instant message application configured according to the present disclosure) to one or more of the computer systems 402. Alternatively, the computer systems 402 may each employ dedicated instant messaging applications configured according to the present disclosure to provide collapsible sections within an instant message dialogue to improve readability of the dialogue. The systems 402 may be coupled to the server 412 (and each other) via an intranet or the Internet (via, for example, an Internet service provider (ISP)). Each of the computer systems 402 includes a processor 404 (including one or more central processing units (CPUs)) that is coupled to a memory subsystem 406 (which includes an application appropriate amount of volatile and non-volatile memory), an input device 408 (e.g., a keyboard and a mouse), and a display 410 (e.g., a cathode ray tube (CRT) or a liquid crystal display (LCD)). The processors 404 of the computer systems 402 may communicate with each other via, for example, network interface cards (NICs) installed in each of the systems 402.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of displaying instant messages, comprising:
creating a collapsible section in an instant message dialogue;
incorporating information into the collapsible section of the instant message dialogue; and
selectably displaying the information in the instant message dialogue.

2. The method of claim 1, further comprising:
incorporating a title for the collapsible section in the instant message dialogue.

3. The method of claim 1, further comprising:
providing the information incorporated in the collapsible section in the instant message dialogue in a separate window.

4. The method of claim 1, wherein the incorporated information includes text.

5. The method of claim 1, wherein the incorporated information includes an image.

6. The method of claim 1, wherein the incorporated information includes text and an image.

7. An instant messaging application stored on a computer-readable storage medium, the instant message application comprising:
first code for creating a collapsible section in an instant message dialogue;
second code incorporating information into the collapsible section of the instant message dialogue; and
third code for selectably displaying the information in the instant message dialogue.

8. The instant message application of claim 7, further comprising:
fourth code for incorporating a title for the collapsible section in the instant message dialogue.

9. The instant message application of claim 7, further comprising:
fifth code for providing the information incorporated in the collapsible section in the instant message dialogue in a separate window.

10. The instant message application of claim 7, wherein the incorporated information includes text.

11. The instant message application of claim 7, wherein the incorporated information includes an image.

12. The instant message application of claim 7, wherein the incorporated information includes text and an image.
